(19) United States
(12) Patent Application Publication
(10) Pub. No.: US 2011/0181148 A1
(43) Pub. Date: Jul. 28, 2011

(54) BRUSH DEVICE HAVING A SPRING, FOR AN ELECTRIC MACHINE

(76) Inventors: Michael Bayer, Ludwigsburg (DE); Walter Gerschwitz, Moensheim (DE); Gerlinde Gerschwitz, Moensheim (DE)

(21) Appl. No.: 12/734,270

(22) PCT Filed: Sep. 26, 2008
(86) PCT No.: PCT/EP2008/062948

§ 371 Date: Nov. 30, 2010

(30) Foreign Application Priority Data
Oct. 24, 2007 (DE) 102007050803.6

(51) Int. Cl. H01R 39/40

(52) U.S. Cl. 310/247

(57) ABSTRACT

A brush device for an electric machine includes a brush holder, a brush which is accommodated therein and has an integrated stranded wire, and a first spring which prestresses the brush with respect to a commutator. At least one second spring is disposed parallel to the first spring, which prestresses the brush with respect to the commutator.

### BACKGROUND OF THE INVENTION

1. Field of the Invention

The present invention relates to a brush device for an electric machine, having a brush holder, a brush, which is accommodated therein and includes an integrated stranded wire, and a first spring, which prestresses the brush with respect to a commutator.

2. Description of Related Art

Electric machines (e-motors) and direct-current as well as three-phase motors feature pairs of brushes which are prestressed with respect to a commutator.

In most cases, mechanically commutated DC motors (starters) are used for the startup of internal combustion engines. The current is introduced into the armature winding via the commutator by way of one or more pairs of brushes. For the part, cases these brushes are made of a sintered material, which predominantly includes copper and graphite components. The brushes are therefore also referred to as carbon brushes. These brushes as well as the commutator are subject to wear during operation. DC motors are typically designed for short-term operation and normally are suitable for 30,000 to 60,000 switching cycles.

A reduced service life, in particular, comes about if the starter is designed for higher loads and longer operating periods. It is known to insert a helical spring for pressing the carbon brush against the commutator. Because of the radial space restriction of a starter, one compromise manifests itself in the height of the carbon brush, which has a direct influence on the potential wear length and required contact pressure. The contact pressure and the spring constant C are heavily influenced by radial specifications. Contact pressures having a specific characteristic are therefore achievable only by minimal spring constants C.

### BRIEF SUMMARY OF THE INVENTION

It is an object of the present invention to further develop a brush device of the type mentioned in the introduction in such a way that electric machines featuring frequent repeated startups and longer operating periods exhibit an improved service life.

One example embodiment provides a second spring parallel to the first spring, which second spring prestresses the brush with respect to the commutator. This produces the most homogenous contact pressure possible of the brushes on the commutator. An asymmetry with regard to the face pressure of the carbon brush at a high contact pressure, as it occurs in the case of only one spring per carbon brush at a mostly centered contact pressure according to the related art, is avoided according to the present invention. The risk that the contact pressure of the carbon brush will no longer be acting in a homogenous manner along the contact surface due to a high axial length of the carbon brushes is likewise avoided. Furthermore, the parallel affixation of the springs on the brush provides a stable state with regard to axial movements of the carbon brushes at a uniform and evenly distributed contact pressure, in contrast to the related art which uses a centered fixation.

In comparison with a contact pressure generated by only one helical spring, the contact pressure decreases much less during the wear length of the carbon brush. Thus, higher switching numbers with lower wear and longer operating periods of the electric machine are able to be achieved.

According to the present invention, one or more springs are additionally installed on the brush, in parallel next to each other. The overall contact pressure F (x) is therefore made up as follows: Fₒᵥₑᵣₐₗₗ (x)=F₁ (x)+F₂ (x).

According to an example embodiment of the present invention, the stranded wire integrated in the brush is disposed parallel to the first spring in the radial direction. Since the stranded wire is not situated one after the other in the radial direction but in parallel relative to the spring, the wear length of the brush is increased. The increased wear length extends the service life and allows for more frequent repeated starts of e-motors during an at least equally long service life. The stranded wire is made from a copper alloy and pressed into the brush.

As a rule, the possible wear length of a brush is the distance from the contact surface of the brush with respect to the commutator, to the specified end of the pure carbon brush in the radial direction. The specified end is the radial height at which the diameter of the stranded wire in the brush begins.

According to an example embodiment of the present invention, the stranded wire is disposed between the first and the at least second spring, in parallel, in an intermediate shoulder in the brush. This provides the advantage that the wear length of the brush is optimally large and the brush sits in the brush holder in a stable manner.

In an advantageous manner, the radial distance from the commutator to the center of the at least one stranded wire is greater than the distance to a contact surface on the brush of the spring(s). The wear length is therefore increased.

At least two identical springs whose spring constant is essentially of equal magnitude are used in order to obtain the most homogenous system possible. As a result, Fₒᵥₑᵣₐₗₗ (x)=F₁ (x)+F₁ (x)=2·F₁ (x).

The use of two identical springs makes it possible to achieve twice the contact pressure of a current series production spring having a spring constant of Cₛₑᵣᵢₑₛ. The higher contact pressure of the carbon brush exerted on the commutator of an electric machine used as starter therefore leads directly to a. higher switching number. Given the same overall spring constant, the following thus results:

Fₒᵥₑᵣₐₗₗ(x)=Cₒᵥₑᵣₐₗₗ·x=F₁(x)+F₁(x)=2·F₁(x)=2·C₁·x.

Surprisingly, in tests it was discovered that a spring constant C that is as constant as possible is advantageous for a long service life of a mechanically commutated electric machine.

Furthermore, it turned out to be advantageous if spring constant C was as low as possible for the available space. According to an example embodiment of the present invention, the spring constant of the first and second springs is lower than in a brush having a single spring according to the related art (series spring). The use of at least two springs therefore makes it possible to lower spring constant C even further, which is no longer possible in the case of a single spring for production-related reasons. With the aid of at least two springs disposed in parallel, even stronger compressive forces which satisfy the specifications regarding spring constant C are able to be produced. An optimized condition by the combination of two identical springs having spring constant C₁ in relation to a spring rate Cₛₑᵣᵢₑₛ of a conventional spring reads: 2·C₁<Cₛₑᵣᵢₑₛ.

Halving the initial force of two springs, which jointly generate the entire required initial compression force in the prestressed state of the carbon brush, makes it possible to achieve the same initial conditions as when using one spring.

According to an example embodiment of the present invention, the dimensions of the first and second spring are smaller than the dimensions of a brush device having a single spring. The at least two springs are smaller in their diameter and thinner in their thickness, and thus allow the initial force of a spring to be halved in order to satisfy the condition 2·C₁<Cₛₑᵣᵢₑₛ. Reducing the overall spring constant Cₒᵥₑᵣₐₗₗ for the brush device therefore produces a more stable behavior across the service life of the brush device. Minimum spring constant C₁ of each individual spring is therefore able to be achieved in a less cost-intensive and in a simpler manner than the spring constant in a brush device having a single series spring.

In an advantageous manner, the brush device is designed for an overall service life of the electric machine. In order to enable maintenance of the electric machine following the end of the service life of the electric machine, the brush device in the electric machine is able to be exchanged.

It is understood that the aforementioned features, which will be discussed below, are able to be used not only in the individually indicated combination but in other combinations as well.

### BRIEF DESCRIPTION OF THE SEVERAL VIEWS OF THE DRAWING

FIG. 1 shows a schematic side view of a brush device.

FIG. 2 shows a schematic plan view of the brush device.

FIG. 3 shows a schematic side view of the brush device having a stranded wire parallel to the spring.

FIG. 4 shows a displacement-force diagram of the brush device.

### DETAILED DESCRIPTION

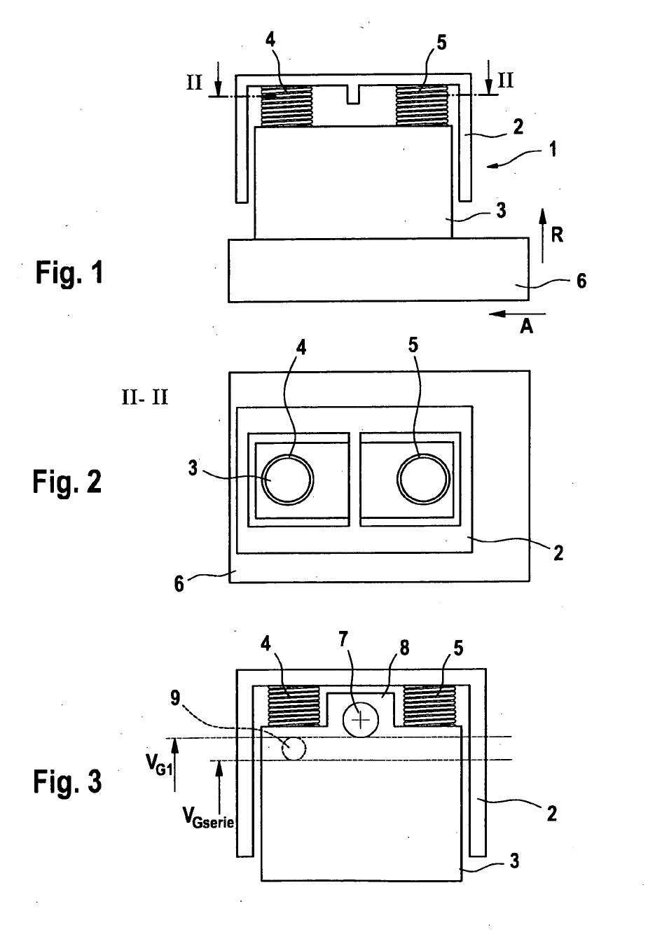

FIG. 1 shows a schematic side view of a brush device 1 according to the present invention for an electric machine such as, for instance, a mechanically commutated DC motor, which is used as starter for an internal combustion engine in a vehicle. Brush device 1 includes a brush holder 2 in which a brush 3 is accommodated. Brush 3 is made of a material having a large graphite component and therefore is also referred to as carbon brush. Using a first and second spring 4, 5 of brush holder 2, brush 3 is pressed against a rotating commutator 6 and is prestressed in this manner. First and second spring 4, 5 are situated parallel to one another in the radial direction. In one special development, the springs have the same spring constant C₁ and have the same dimensions, e.g., diameter, length and thickness of the spring wire. In another special development, both springs 4, 5 may also have different spring constants C if axial loads should require this. First and second spring 4, 5 are helical springs.

FIG. 2 shows a schematic plan view of brush device 1 illustrated in FIG. 1. Situated in parallel inside brush holder 2 are identically sized springs 4, 5, which ensure a homogenous contact force behavior of brush 3 relative to a seat on commutator 6.

FIG. 3 shows a schematic side view of brush device 1 according to the present invention featuring a further essential idea of the present invention; according to this idea, a stranded wire 7 of brush 3 is not disposed in the conventional manner, in series in the radial direction, i.e., in series with spring 4, 5, but parallel to first spring 4 and second spring 5. As illustrated in FIG. 3, stranded wire 7 is pressed into an intermediate shoulder 8 of brush 3.

The parallel placement of stranded wire 7 with respect to springs 4, 5 produces an additional wear length, which is shown in FIG. 3 as wear limit V_{G1} by an axial line in abstract form. In comparison, a stranded wire 9 is plotted as dashed line in front of spring 5 in the radial direction, as it is installed in the related art for instance, and thus forms a wear limit V_{Gseries}. Raising the wear length while keeping the marginal conditions constant directly leads to a longer service life of the commutation system and the starter.

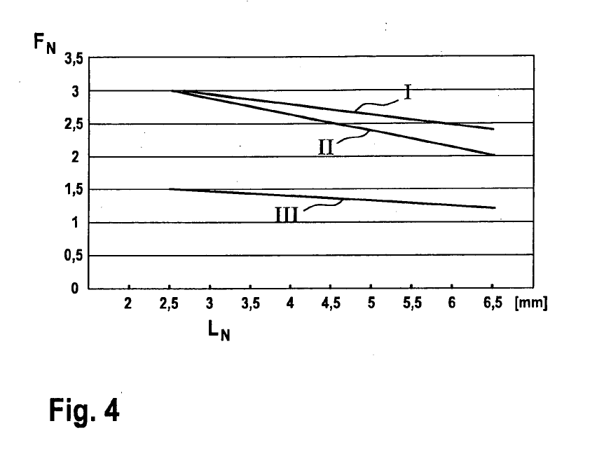

FIG. 4 shows a displacement/force diagram featuring spring characteristics of springs for the brush device. Upper spring characteristic I shows normalized spring force F_{N} relative to spring length L_{F} when using two springs having a low spring constant C₁ according to the present invention. The diagram shows that the spring force decreases slightly across a larger spring length.

Below, a spring characteristic II of a conventional single spring has been plotted as it is installed in a brush device according to the related art. Spring force F_{N} decreases to a greater extent at a larger spring length L_{F}, i.e., with greater wear of brush 3, than in the case of two springs 4, 5 disposed in parallel and having a low spring constant C.

Spring characteristic III shows normalized spring force F_{N} relative to spring length L_{F} for a single spring 4 or 5, as it is installed in brush device 1 according to the present invention. Using at least two springs 4, 5, which are disposed in parallel and press brush 3 against commutator 6, generates a homogenous contact pressure which is as high as possible at frequent restarts and longer operating periods in mechanically commutated electric machines.

All the figures show only schematic illustrations which are not to scale.

1-8. (canceled)

9. An electric machine, comprising:
a brush device including:
a brush holder;
a brush accommodated within the brush holder and having an integrated stranded wire; and
a first spring prestressing the brush with respect to a commutator;
wherein the stranded wire is pressed into an intermediate shoulder of the brush next to the first spring.

10. The electric machine as recited in claim 9, wherein a radial distance from the commutator to the center of a cross-section of the stranded wire is greater than a radial distance from the commutator to a contact surface on the brush where the first spring contacts the brush.

11. The electric machine as recited in claim 10, wherein the brush device further includes a second spring disposed parallel to the first spring and prestressing the brush with respect to the commutator, and wherein the stranded wire is pressed into the intermediate shoulder of the brush between the first and second springs, and parallel to the first and second springs.

12. The electric machine as recited in claim 10, wherein the brush device further includes a second spring disposed parallel to the first spring and prestressing the brush with respect to the commutator, and wherein a spring constant of the first spring is substantially equal to a spring constant of the second spring.

13. The electric machine as recited in claim 11, wherein a spring constant of the first spring is substantially equal to a spring constant of the second spring.

14. The electric machine as recited in claim 11, wherein the brush device is exchangeable.
